(19) United States
(12) Patent Application Publication
(10) Pub. No.: US 2005/0273705 A1
(43) Pub. Date: Dec. 8, 2005

(54) Method and system for automatically creating network software applications

(75) Inventor: Robert C. McCain, Willowbrook, IL (US)

Correspondence Address: Lesavich High-Tech Law Group, P.C., Suite 325, 39 S. LaSalle Street, Chicago, IL, 60603, US

(73) Assignee: Fortellio, LLC, Willowbrook, IL (US)

(21) Appl. No.: 11/033,360

(22) Filed: Jan. 11, 2005

Related U.S. Application Data
(60) Provisional application No. 60/578,224, filed on Jun. 8, 2004.

(51) Int. Cl. G06F 17/21

(52) U.S. Cl. 715/513; 715/764

(57) ABSTRACT

A method and system for automatically creating network software applications. An existing web-site is visited on a communications network. New electronic content and new functionality is added. Electronic content and functionality for a new web-site is automatically re-generated. A brand new web-site can also be created using one or more pre-existing solutions available from a solutions database. Electronic content and functionality for a new web-site is automatically re-generated selected solutions. The method and system described here provides a tool set used to rapidly and automatically develop web-based applications. The method and system is used for automatically designing, implementing and deploying a new web-site or web-site application or enhancing existing web-sites or web-site applications.

### CROSS REFERENCES TO RELATED APPLICATIONS

This application claims priority to U.S. Provisional Application No. 60/578,224 filed on Jun. 8, 2004, the contents of which are incorporated by reference.

### FIELD OF THE INVENTION

This invention relates to developing software applications used on computer networks such as the Internet. More specifically, it relates to a method and system for automatically creating network software applications.

### BACKGROUND OF THE INVENTION

The Internet and World-Wide-Web have changed the way organizations conduct business. Virtually every organization has a web-site that provides information about the organization and a description of the goods and/or services an organization may offer. As is known in the art, a “web-site” is group of related mark-up language documents and associated graphics and multi-media files, scripts, and databases, etc. that are served up by a server on the World-Wide-Web via the Internet. Business organizations also provide an electronic commerce (e-commerce) interface that allows users to purchase goods and/or services from such organizations.

There are many different type of web-sites on a spectrum ranging from very simple to very complex. Designing, implementing and deploying a web-site requires knowledge of markup languages such as Hyper Text Markup Language (HTML), eXtensible Markup Language (XML), programming languages such as JAVA, C++, C#, computer graphics functionality, multi-media functionality, etc. A knowledge of communications protocols such as Hyper Text Transfer Protocol (HTTP), Transmission Control Protocol (TCP), Internet Protocol (IP), e-mail protocols such as Simple Mail Transfer Protocol (SMTP), e-commerce protocols, encryption and other security protocols and many other types of protocols for various kinds of web functionalities.

There are many problems associated with designing, implementing and deploying a web-site. One problem is that when a new web-site is to be deployed, it often takes many weeks or months to design, implement and deploy a it.

Another problem is that when a web-site is changed, for example, to include new goods and/or services for an organization, substantial programming expertise is required to implement the changes.

There have been attempts to automate and/or simplify one or more parts of the process necessary to design, implement and deploy a web-site. For example, U.S. Pat. No. 6,569,207, entitled “Converting schemas to component models” that issued to Sundaresan teaches “a system for automatically generating class specifications from extensible Markup Language (XML) schemas and then automatically instantiating objects from those class specifications using data contained in XML documents.”

U.S. Pat. No. 6,499,035, entitled “Licensing java objects” that issued to Sobeski teaches “the licensing of Java objects is in disclosed. In one embodiment, a computerized system includes a Java object, a license file, and a license manager. The license file is in associated with the Java object. The license manager validates the Java object, based on the license file.”

U.S. Pat. No. 6,418,448, entitled “Method and apparatus for processing markup language specifications for data and metadata used inside multiple related Internet documents to navigate, query and manipulate information from a plurality of object relational databases over the web” that issued to Sarkar, teaches “the present invention provides a system for navigation through multiple documents in Extensible Markup Language and Resource Description Framework to inspect data/metadata in order to either start a transaction on selected item(s) in separate thin client window(s) with persistent connectivity through Internet Inter ORB Protocol or implicitly trigger read-only queries in Structured Query Language (SQL) represented in Resource Description Framework against a unified virtual Database defined over multiple physical disparate object relational databases over the web. An implicitly generated query retrieves desired sets of properties and entities presented in documents of Extensible Markup Language and Resource Description Framework for further navigation. Container types in Resource Description Framework are mapped by this invention to record and table types in a normalized relational model where URIs locating elements in relational schema components over the web are stored as primary keys/foreign keys in normalized tables. Methods and operators on such web objects are defined as part of user-defined package definitions in object relational schema where object request brokers apply such methods or operators on result sets from relational operations anywhere on the web. This invention uniquely incorporates two distinct stages of SQL computations for a collaborative method of preparation, execution and resolution of an object SQL query over disparate locations of multiple object relational databases on the web.”

U.S Pat. No. 6,393,496, entitled “System, method, and computer program product for workflow processing using internet interoperable electronic messaging with mime multiple content type” that issued to Ambler, et. al. teaches “a client computer in a communications network with a server computer assembles a record set that has a MIME declaration header with a multipart content type and a content sub-type indicative of a workflow media type. The first client computer also assembles a binary file having therein an encoded workflow specification. The record set is then transmitted with the binary file to the communications network. A second client computer on the communications network receives both the record set and the binary file and begins decoding the workflow specification. The second client computer uses an application program to execute the decoded workflow specification so as to perform all or a portion of the workflow process that is specified therein. The workflow specification is optionally written in Extensible Mark-up Language (XML).”

U.S. Pat. No. 6,381,743, entitled “Method and system for generating a hierarchial document type definition for data interchange among software tools” that issued to Mutschler, III teaches “a method is disclosed for use in a software development framework having a repository and at least two software systems. The repository contains a meta-model and the software systems, which store instances of the meta-model. The method enables exchange of the instances of the metadata among the software systems using a generalized data transfer language. The method comprises the steps of extracting a fixed component and a list of repeated components of the metadata; extracting a variable component form the list of repeated components; parsing the variable component into a first set of constituent components for a first instance of the variable component; and, determining the hierarchical order and inheritance of the first set of constituent components in the list of repeated components. Next, each of the first set of constituent components are transformed into corresponding components of the generalized software language. The first instance of the variable component is then transformed into corresponding components of the generalized software language. The list of repeated components is updated and the previous five steps are repeated for another instance of the variable component. The list of repeated components are next transformed into corresponding components of the generalized software language. After this, the fixed components are transformed into corresponding components of the generalized software language. Finally, the corresponding components are distributed to the second instance of the software model.”

U.S. Pat. No. 6,253,366, entitled “Method and system for generating a compact document type definition for data interchange among software tools” that issued to Mutschler, III teaches “a method is disclosed for use in a software development framework having a repository and at least two software systems. The repository contains a meta-model and the software systems, which store instances of the meta-model. The method enables exchange of the instances of the meta-model among the software systems using a generalized data transfer language. The method comprises the steps of extracting a fixed component and a variable of the meta-model; parsing the variable component into a first set of constituent components for a first instance of the variable component; and extracting a list of repeated components from the first set of constituent components. Next, each of the members of the list of repeated components is transformed into components of a generalized software language. Then, the first set of constituent components are transformed into corresponding components of the generalized software language. The first instance of the variable component is then transformed into corresponding components of the generalized software language. The previous five steps are repeated for additional instances of the variable component. After this, the fixed component is transformed into corresponding components of the generalized software language. Then, the corresponding components are distributed among the software systems. The distributed components in the generalized software language can then be used to control the syntax of the generalized data transfer language when used to exchange instances of the meta-model.”

U.S. Pat. No. 6,182,029, entitled “System and method for language extraction and encoding utilizing the parsing of text data in accordance with domain parameters” that issued to Friedman teaches “a computerized method for extracting information from natural-language text data includes parsing the text data to determine the grammatical structure of the text data and regularizing the parsed text data to form structured word terms. The parsing step, which can be performed in one or more parsing modes, includes the step of referring to a domain parameter having a value indicative of a domain from which the text data originated, wherein the domain parameter corresponds to one or more rules of grammar within a knowledge base related to the domain to be applied for parsing the text data. Preferably, the structured output is mapped back to the words in the original sentences of the text data input using XML tags.”

U.S. Published patent application Ser. No. 20020124045 entitled “Interface between front-end systems and back-end systems” published by Moore, et al. teaches “an interface interfaces between front-end systems and back-end systems in a manner whereby their communication formats may be different and they may change. There is an engine, a node layer of nodes and a utility layer of utilities. An engine has an engine object which instantiates processor, script loader, parser, and script builder objects. An XML script contains a process map for associating incoming messages from the front-end systems with nodes. The association is determined by the parser object. The engine has no specific business logic, this logic being represented by the nodes. The nodes expose their business logic capabilities to the engine, allowing it to dynamically maintain its process map. Messages are routed to the relevant nodes, which communicate with the relevant back-end systems via the utilities. Messages are passed between the nodes and the engine objects using a hashtable associating keys with values.”

U.S. Published patent application Ser. No. 20030233349, entitled “media player system” published by Stem teaches a “method, system, and computer readable medium are provided for the media player system. The present invention provides for associating content with media and integrating the content associated with media into a pane displayed by a media player. The media player system includes a shuttle component to obtain provider data, a first database component to store content and associated media metadata, a user interface to manage the first database user interface, an input component to insert provider data into the first database, and an output component to generate pane and search files. The media player system includes a user interface to display a pane for the media with associated content. The pane includes a media display component to display streamed media and a content display component to display content associated with the streamed media.”

U.S. Published patent application Ser. No. 20030163450, entitled “Brokering semantics between web services” published by Borenstein teaches “methods for brokering between services, including, in one exemplary embodiment of a method, providing a first and second service, each service having associated therewith a request and a response data structure, and generating a transformation for producing data conforming to the request data structure for the second service, corresponding to data conforming to the response data structure for the first service. Systems are also described and claimed.”

U.S. Published patent application Ser. No. 20030023514, entitled “Unified automatic online marketplace and associated web site generation and transaction system” published by Adler teaches “a unified automatic online marketplace and associated seller Web site generation and transaction system including a seller's interface configured to receive seller's product or service data, seller's data, the seller's Web site choices, and seller's marketplace choices, and a software engine configured to automatically and dynamically generate one or more marketplaces based on seller's product or service data, and, based on said seller's product or service data, Web site choices, and marketplace choices, generate Web sites for the seller.”

However, these inventions still do not solve all of the problems associated with automating and/or simplifying one or more parts of the process necessary to design, implement and deploy a web-site. Thus, it desirable to provide a method and system for automatically designing, implementing and deploying a web-site.

### SUMMARY OF THE INVENTION

In accordance with preferred embodiments of the present invention, some of the problems associated with automatically designing, implementing and deploying a web-site are overcome. A method and system for automatically creating network software applications is presented.

In one embodiment, an existing web-site is visited on a communications network. Electronic content and functionality from an existing web-site is saved in a new web-site application template. New electronic content and new functionality is added to the new web-site application template. Electronic content and functionality for a modified web-site is automatically re-generated using the new web-site application template.

In another embodiment, a new web-site application template is created on a network device. One or more existing solutions from plural available solutions are selected. The one or more selected solutions are added to the new web-site application template. New electronic content is created from the new web-site application template.

The new electronic content is securely transmitted via a communications network to a server that will host the new web-site. The electronic content is automatically installed on the server, thereby creating a new web-site on the server.

The method and system described here provides a tool set used to rapidly and automatically develop web-based applications using existing and new content and functionality.

The foregoing and other features and advantages of preferred embodiments of the present invention will be more readily apparent from the following detailed description. The detailed description proceeds with references to the accompanying drawings.

### BRIEF DESCRIPTION OF THE DRAWINGS

Preferred embodiments of the present invention are described with reference to the following drawings, wherein:

FIG. 1 is a block diagram illustrating an exemplary network software application creation system;

FIG. 2 is a block diagram illustrating an exemplary screen dump of the project manager interface;

FIG. 3 is a block diagram illustrating an exemplary screen dump of a solution engine interface;

FIG. 4 is a block diagram illustrating an exemplary screen dump of an interface design tool interface;

FIG. 5 is a block diagram illustrating an exemplary screen dump of specialized web-browser interface;

FIG. 6 is a flow diagram illustrating a method for automatically creating a modified web-site;

FIG. 7 is a block diagram illustrating an exemplary encryption method;

FIG. 8 is a block diagram illustrating an exemplary decryption method;

FIG. 9 is a flow diagram illustrating a method for automatically creating a modified web-site; and

FIG. 10 is a block diagram illustrating additional details of the method the of FIG. 9;

FIG. 11 is a block diagram illustrating a method for storing a created solution;

FIG. 12 is a flow diagram illustrating a method for creating a new web-site;

FIG. 13 is a data flow diagram illustrating additional details of selecting a solution; and

FIG. 14 is a data flow diagram further illustrating additional details of selecting a solution.

### DETAILED DESCRIPTION OF THE INVENTION

Network software application creation system

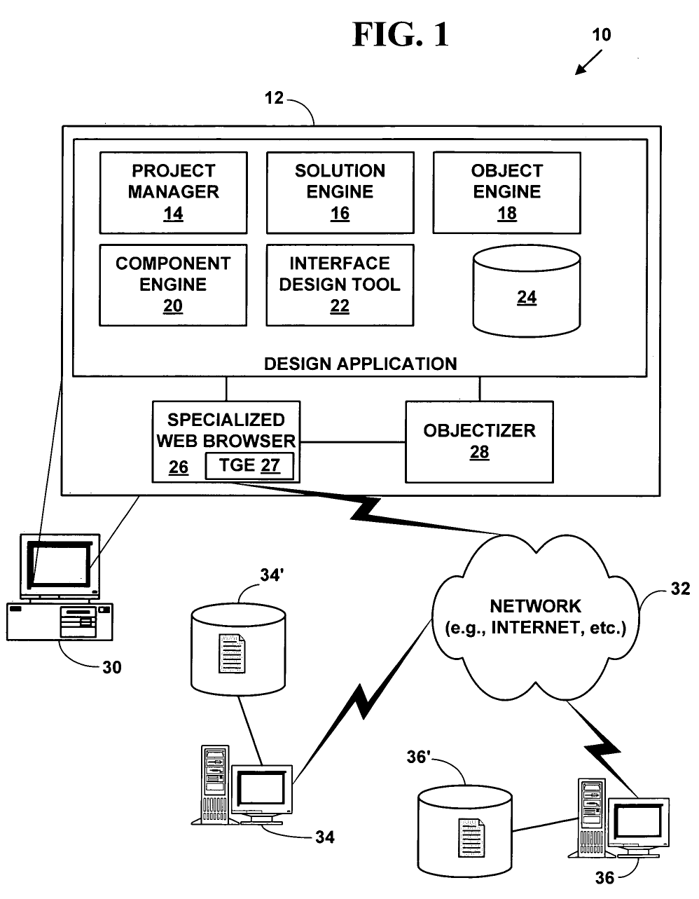

FIG. 1 is a block diagram illustrating a network software application creation system 10. The network software application creation system 10 includes, but is not limited to, an automated design application 12, comprising a project manager 14, a solution engine 16, an object engine 18, a component engine 20 and an interface design tool 22, and one or more databases 24, one of which is illustrated. The network software application creation system 10 further includes a specialized web-browser 26 with a template generation engine 27 and an objectizer 28 running on one or more network devices 30 (one of which is illustrated). However, the present invention is not limited to these components and more, fewer and other types of components can also be used to practice the invention.

The one or more network devices 30 include, but are not limited to, one or more computers (one of which is illustrated) with an associated display. The display presents a windowed graphical user interface (GUI) with multiple windows to a user.

The one or more computers 30 may be replaced with client terminals in communications with one or more servers, a personal digital/data assistant (PDA), a laptop computer, a mobile computer, an Internet appliance, one or two-way pagers, mobile phones, or other similar mobile, non-mobile, desktop or hand-held electronic devices.

The network software application creation system 10 is in communications with a communications network 32 (e.g., the Internet, intranet, Public Switch Telephone Network (PSTN), Local Area Network, (LAN), Wide Area Network (WAN), etc.). The communications includes, but is not limited to, communications over a wire connected to the network devices 30, wireless communications, and other types of communications using one or more communications and/or networking protocols.

The communications network 32 may include one or more gateways, routers, or bridges. As is known in the art, a gateway connects computer networks using different network protocols and/or operating at different transmission capacities. A router receives transmitted messages and forwards them to their correct destinations over the most efficient available route. A bridge is a device that connects networks using the same communications protocols so that information can be passed from one network device to another.

Preferred embodiments of the present invention includes network devices and interfaces that are compliant with all or part of standards proposed by the Institute of Electrical and Electronic Engineers (IEEE), International Telecommunications Union-Telecommunication Standardization Sector (ITU), European Telecommunications Standards Institute (ETSI), Internet Engineering Task Force (IETF), U.S. National Institute of Security Technology (NIST), American National Standard Institute (ANSI), Wireless Application Protocol (WAP) Forum, Data Over Cable Service Interface Specification (DOCSIS) Forum, Bluetooth Forum, ADSL Forum or other standards bodies or forums. However, network devices and interfaces based on other standards could also be used.

IEEE standards can be found on the World Wide Web at the Universal Resource Locator (URL) “www.ieee.org.” The ITU, (formerly known as the CCITT) standards can be found at the URL “www.itu.ch.” ETSI standards can be found at the URL “www.etsi.org.” IETF standards can be found at the URL “www.ietf.org.” The NIST standards can be found at the URL “www.nist.gov.” The ANSI standards can be found at the URL “www.ansi.org.” The DOCSIS standard can be found at the URL “www.cablemodem.com.” Bluetooth Forum documents can be found at the URL “www.bluetooth.com.” WAP Forum documents can be found at the URL “www.wapforum.org.” ADSL Forum documents can be found at the URL “www.adsl.com.”

The one or more network devices 30 include a protocol stack with multiple layers based on the Internet Protocol or Opens Systems Interconnection (OSI) reference model.

As is known in the art, the Internet Protocol reference model is a layered architecture that standardizes levels of service for the Internet Protocol suite of protocols.

The Internet Protocol reference model comprises in general from lowest-to-highest, a link, network, transport and application layer.

As is known in the art, the OSI reference model is a layered architecture that standardizes levels of service and types of interaction for computers exchanging information through a communications network. The OSI reference model separates network device-to-network device communications into seven protocol layers, or levels, each building-and relying--upon the standards contained in the levels below it. The OSI reference model includes from lowest-to-highest, a physical, data-link, network, transport, session, presentation and application layer. The lowest of the seven layers deals solely with hardware links; the highest deals with software interactions at the application-program level.

The communications network 32 includes, but is not limited to data networks using the Transmission Control Protocol (TCP), User Datagram Protocol (UDP), Internet Protocol (IP) and other data protocols.

As is know in the art, TCP provides a connection-oriented, end-to-end reliable protocol designed to fit into a layered hierarchy of protocols which support multi-network applications. TCP provides for reliable inter-process communication between pairs of processes in network devices attached to distinct but interconnected networks. For more information on TCP see Internet Engineering Task Force (ITEF) Request For Comments (RFC)-793, the contents of which are incorporated herein by reference.

As is know in the art, UDP provides a connectionless mode of communications with datagrams in an interconnected set of computer networks. UDP provides a transaction oriented datagram protocol, where delivery and duplicate packet protection are not guaranteed. For more information on UDP see IETF RFC-768, the contents of which incorporated herein by reference.

As is known in the art, IP is an addressing protocol designed to route traffic within a network or between networks. IP is described in IETF Request For Comments (RFC)-791, the contents of which are incorporated herein by reference. However, more fewer or other protocols can also be used on the communications network 28 and the present invention is not limited to TCP/UDP/IP.

The communications network 32 also provides secure communications. As is known in the art, “encryption” is the process of transforming information so it is unintelligible to everyone but an intended recipient. “Decryption” is the process of transforming encrypted information so that it is intelligible again. With most cryptographic schemes, the ability to keep encrypted information secret is based not on the cryptographic method, which is widely known, but on a “key” that is used with the method to produce an encrypted result or to decrypt previously encrypted information.

In general, there are two kinds of cryptosystems: “symmetric” and “asymmetric.” Symmetric cryptosystems use the same key (e.g., a secret key) to encrypt and decrypt a message. Symmetric cryptosystems are also called “private-key” cryptosystems.

Asymmetric cryptosystems use two keys; one key (e.g., a public key) to encrypt a message and a different key (e.g., a private key) to decrypt it. Asymmetric cryptosystems are also called “public-key” cryptosystems.

Public-key encryption uses a pair of keys, a “public key” and a “private key.” The key pairs are associated with an entity that needs to authenticate its identity electronically, to sign data with a digital signature, to exchange data securely, to encrypt data, to decrypt data, etc. A public key is publicly published and is used by others to send encrypted data. However, a corresponding private key is kept secret. Data encrypted with a public key is decrypted with a corresponding private key.

As is known in the art, RSA is a public key encryption system which can be used both for encrypting messages and making digital signatures. The letters RSA stand for the names of the inventors: Rivest, Shamir and Adleman. For more information on RSA, see U.S. Pat. No. 4,405,829, now expired, incorporated herein by reference.

The NIST has developed a new encryption standard, the Advanced Encryption Standard (“AES”) to keep government information secure. AES is intended to be a stronger, more efficient successor to Triple Data Encryption Standard (“3DES”). More information on NIST AES can be found at the URL “www.nist.gov/aes.”

As is known in the art, DES is a popular symmetric-key encryption method developed in 1975 and standardized by ANSI in 1981 as ANSI X.3.92, the contents of which are incorporated herein by reference. As is known in the art, 3DES is the encrypt-decrypt-encrypt (“EDE”) mode of the DES cipher algorithm. 3DES is defined in the ANSI standard, ANSI X9.52-1998, the contents of which are incorporated herein by reference. DES modes of operation are used in conjunction with the NIST Federal Information Processing Standard (“FIPS”) for data encryption (FIPS 46-3, October 1999), the contents of which are incorporated herein by reference.

The NIST approved a FIPS for the AES, FIPS-197. This standard specified “Rijndael” encryption as a FIPS-approved symmetric encryption algorithm that may be used by U.S. Government organizations (and others) to protect sensitive information. The NIST FIPS-197 standard (AES FIPS PUB 197, November 2001) is incorporated herein by reference.

The NIST approved a FIPS for U.S. Federal Government requirements for information technology products for sensitive but unclassified (“SBU”) communications. The NIST FIPS Security Requirements for Cryptographic Modules (FIPS PUB 140-2, May 2001) is incorporated herein by reference.

As is known in the art, the Secure Sockets Layer (SSL) protocol is a protocol layer which may be placed between a reliable connection-oriented network layer protocol (e.g. TCP/IP) and the application protocol layer (e.g. HyperText Transport Protocol (HTTP)). SSL provides for secure communications between a source and destination by allowing mutual authentication, the use of digital signatures for integrity, and encryption for privacy.

The SSL protocol is designed to support a range of choices for specific security methods used for cryptography, message digests, and digistal signatures. The security methods are negotiated between the source and destingation at the start of establishing a protocol session. The SSL 2.0 protocol specification, by Kipp E. B. Hickman, 1995 is incoroporated herein by reference. More information on SSL is available at the URL See “netscape.com/eng/security/SSL_{—}2.html.”

As is known in the art, Transplort Layer Security (TLS) provides communications privacy over the Internet. The protocol allows /server applications to communicate over a transport layer (e.g., TCP) in a way that is designed to prevent eavesdropping, tampering, or message forgery. For more information on TLS see IETF RFC-2246, incorporated herein by reference.

As is known in the art, IP Security (IPsec) is security protocol that provides authentication and encryption over the Internet. Unlike SSL, which provides services at OSI layer 4 and secures two applications, IPSec works at layer 3 (i.e., the OSI network layer) and secures networks including VPNs. The phone-based home gateway interface 18 also provides IPsec for secure communications (e.g., for VPNs). , For more information on IPsec see IETF RFC-2401, the contents of which are incorporated by reference.

However, the present invention is not limited to the secure communications methods and protocols described and other security method and protocols can be used to practice the invention.

The communications network 32 includes plural server devices 34 (only one of which is illustrated) with one or more associated databases 34′ (only one of which is illustrated). The plural server devices 34 include, but are not limited to, World Wide Web servers, Internet servers, file servers, other types of electronic information servers, and other types of server network devices (e.g., edge servers, firewalls, routers, gateways, etc.).

The network software application creation system 10 also includes one or more solution servers 36 (one of which is illustrated) with one or more associated databases 36′ including a library of pre-existing solutions. The one or more solution servers 36 are used to allow storage of new solutions and retrieval of existing solutions created by the solution engine 16 that provide new electronic content and new functionality for a web-site that is being created or enhanced.

A “solution” includes, but is not limited to, electronic content and software instructions to accomplish a desired functionality. A solution includes non-binary components including but not limited to, a solution definition, solution processing instructions, parameters, URLs including locations of other components, scripts, schemas, mark-up language components, plain electronic text, etc. A solution also include binary components, including but not limited to, digital graphics, digital photographs, digital audio, digital video, executable components, and other types of components stored in a pre-determined non-ASCII format. As is known in the art, the American Standard Code for Information Interchange (ASCII) standard is the de facto world-wide standard for the coding numbers used by computers to represent upper and lower-case Latin letters, numbers, punctuation, etc. The solutions may be stored, all or in part, as specialized objects called “C2 objects” as is described below.

For example, the solution server 36 may include a pre-existing solution for adding the current weather to a web-page. The current weather solution includes the electronic content and functionality to obtain a set of current weather readings for a user from another server on the communications network 32, format the current weather readings and appropriately display the current weather readings. Other pre-existing solutions stored on the solution server 36, include but are not limited to for example, a new user login solution, a welcome page solution, a user registration solution, an electronic-commerce (e-commerce) solution, a mobile commerce (m-commerce) solution, an electronic-business (e-business) method solution, and other types of solutions that are pre-existing and selectable from the database 36′ via solution server 36 and the project manager 14.

The communications network 32 may also include portions of a Public Switched Telephone Network (PSTN) or cable television network (CATV) that connects the via one or more twisted pairs of copper wires, coaxial cable, fiber optic cable, other connection media or other connection interfaces with corresponding wired connection protocols (e.g., DSL, ADSL, ISDN, etc.) The PSTN is any public switched telephone network provided by AT&T, GTE, Sprint, MCI, SBC, Verizon and others.

An operating environment for the devices of the network software application creation system 10 include a processing system with one or more high speed Central Processing Unit(s) (“CPU”), processors and one or more memories. In accordance with the practices of persons skilled in the art of computer programming, the present invention is described below with reference to acts and symbolic representations of operations or instructions that are performed by the processing system, unless indicated otherwise. Such acts and operations or instructions are referred to as being “computer-executed,” “CPU-executed,” or “processor-executed.”

It will be appreciated that acts and symbolically represented operations or instructions include the manipulation of electrical signals by the CPU or processor. An electrical system represents data bits which cause a resulting transformation or reduction of the electrical signals, and the maintenance of data bits at memory locations in a memory system to thereby reconfigure or otherwise alter the CPU's or processor's operation, as well as other processing of signals. The memory locations where data bits are maintained are physical locations that have particular electrical, magnetic, optical, or organic properties corresponding to the data bits.

The data bits may also be maintained on a computer readable medium including magnetic disks, optical disks, organic memory, and any other volatile (e.g., Random Access Memory (“RAM”)) or non-volatile (e.g., Read-Only Memory (“ROM”), flash memory, etc.) mass storage system readable by the CPU. The computer readable medium includes cooperating or interconnected computer readable medium, which exist exclusively on the processing system or can be distributed among multiple interconnected processing systems that may be local or remote to the processing system.

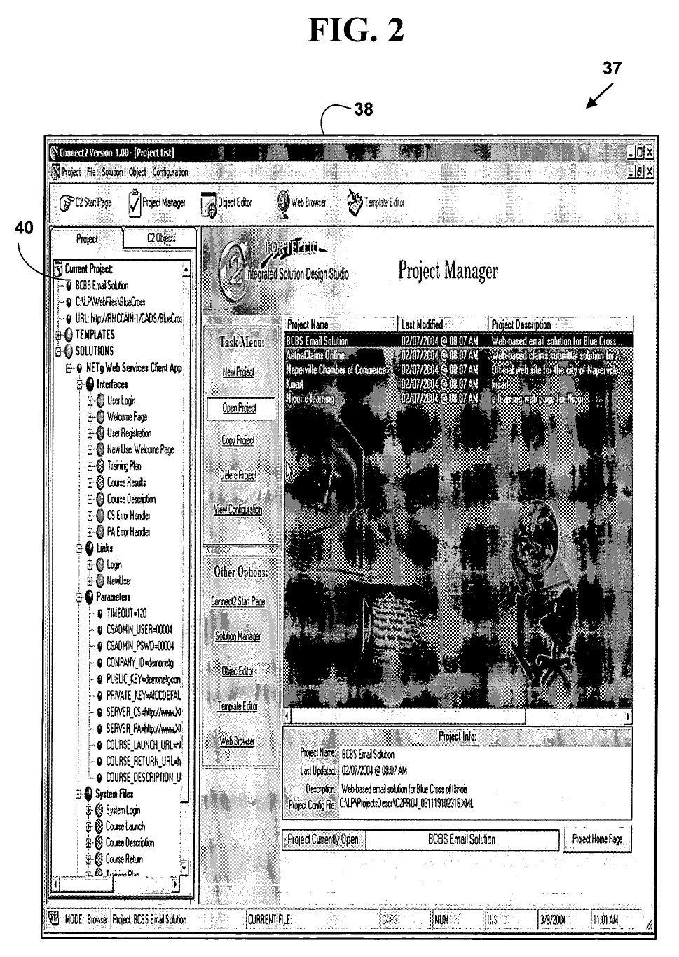

FIG. 2 is a block diagram of a screen dump 37 of an exemplary graphical interface 38 to the project manager 14. The project manager interface 38 gathers, organizes and tracks resources used to build a web-based application. It is tightly integrated with other modules and allows one click switching between design related tasks and project management tasks. It uses a project tree 40 that allows easy navigation through project resources. Project files can also be linked to external editors and development environments. The project manager 14 manages projects. A “project” is a set of components, including, but not limited to objects templates, interfaces, resources, etc. used to build a web-based application.

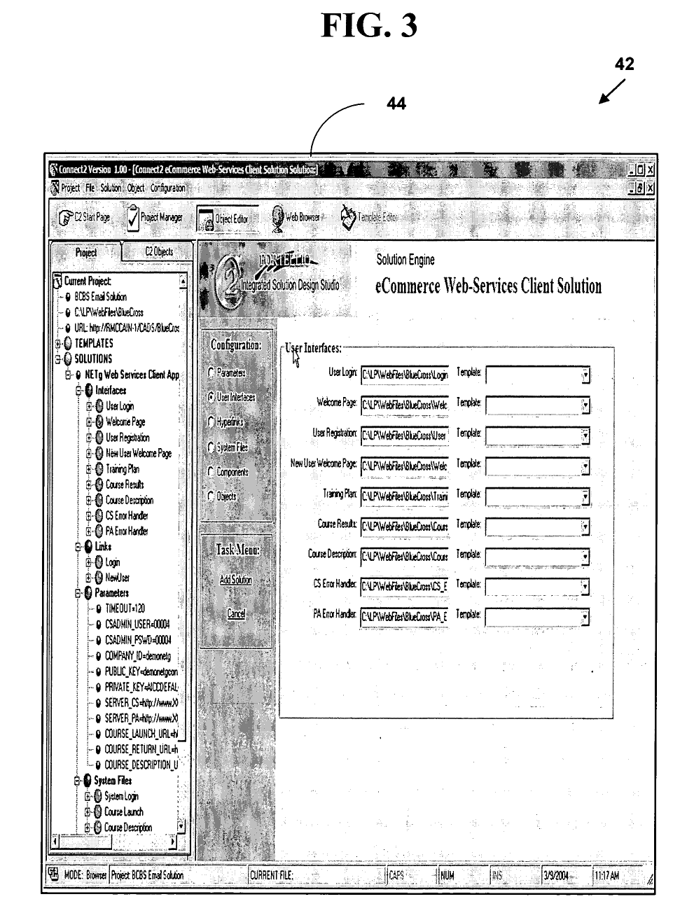

FIG. 3 is a block diagram of a screen dump 42 of an exemplary graphical interface 44 to the solution engine 16. Generic or custom problem solutions including various types of functionality can be added to a project to capture specific desired solutions (e.g., e-commerce and e-business processes and functions, etc.). The solution engine 16 automatically integrates interfaces, objects, parameters, system files and components into a project.

The object engine 18 manages the implementation of specialized objects called C2 objects within a project. A “C2 object” includes, but is not limited to, software instructions, event controls, and components that can run within the web browser environment or access web-based services and/or communicate with back-end services.

The component engine 18 processes processing instructions, parameters, scripts, schemas, mark-up language tags, binaries including images, executables, connection objects, etc. and stores them in plural component definition units in extensible Markup Language (XML) format. In one embodiment, non-binary units are encoded and/or encrypted. In another embodiment, non-binary units are not encoded or encrypted. The multiple binary units are compressed and compiled into a single unit called a C2 component. The C2 components are added to a C2 component library stored in one or more databases 24. The component engine 20 automatically generates all code necessary to create user interfaces, reference system components, data base connections, e-commerce connections, communication protocol connections, etc. C2 components may also be used to store solutions in the one or more solution databases 36′ available via the one or more solution servers 36.

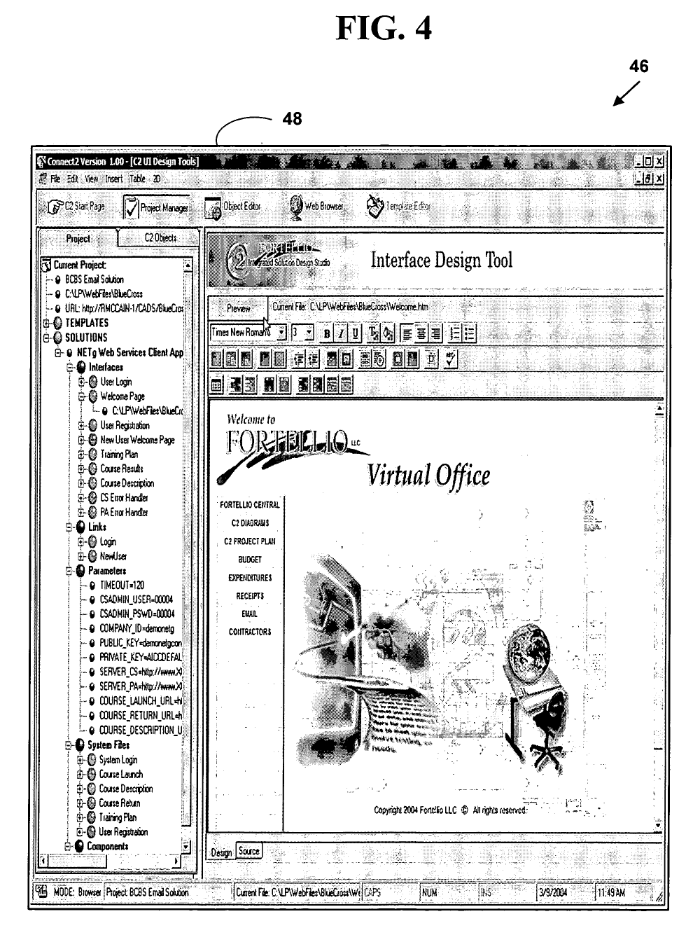

FIG. 4 is a block diagram of a screen dump 46 of an interface 48 to the interface design tool 20. The interface design tool 20 tightly integrates a fully functional Hypertext Markup Language (HTML) editor with word processor-like features, a source code editor, spell check, and support for images, video clips, client-side scripts and dynamic HTML (dHTML).

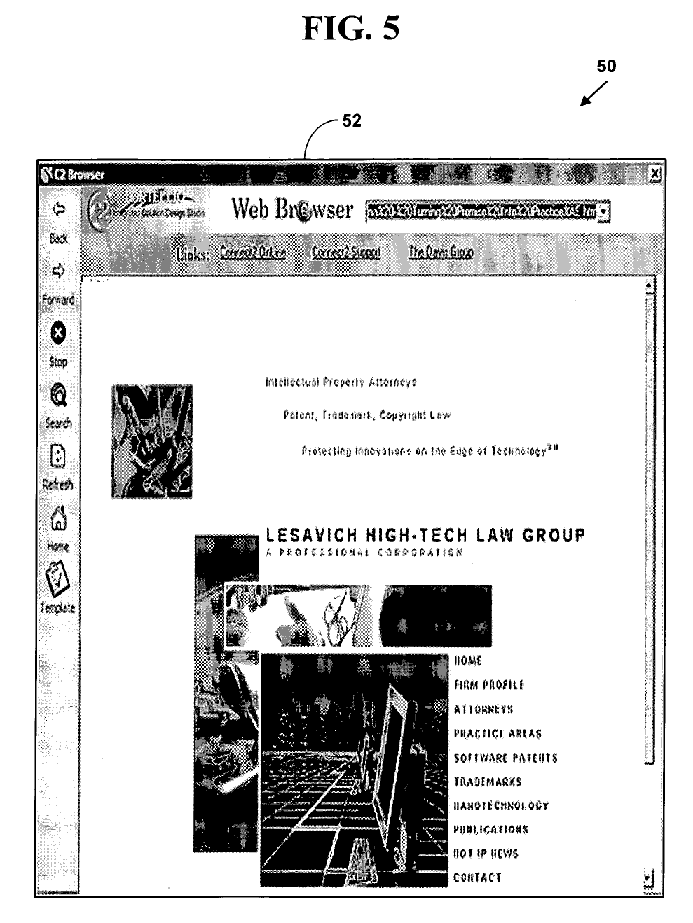

FIG. 5 is a block diagram of a screen dump 50 of an exemplary interface 52 to the specialized web-browser 26. The specialized web-browser 26 includes is a fully functional web browser with a template generator engine 27. As a user browses web-sites on a communications network 32 such as the Internet. In one embodiment, a template generation engine 27 in the web-browser 26 is used to capture a look, feel, content and functionality of almost any existing web-site and use it as a template. In such an embodiment client-side functionality is captured. In another embodiment, both client- side and server-side functionality is captured. In yet another embodiment, only server-side functionality is captured. Use of this specialized web-browser 26 and template generation engine 27 decreases the amount of time and technical knowledge required to develop a custom web-based solution.

The objectizer 28 allows the creation of new C2 objects and the modification existing C2 objects. Using the objectizer 28, a C2 object's look, feel and functionality can be modified using the objectizer's design interface. The objectizer's 28 user interface is almost identical to the user interface of the interface design interface tool 20 interface 48 (FIG. 4). Anything created using the objectizer 28 can be used in a solution or dragged and dropped directly onto a web page. The objectizer 28 provices multi-language, multi-platform support. Any markup code such as HTML, Dynamic HTML (DHTML), XML, JavaScript, and Visual Basic (VB) Script can be objectized into C2 objects. Calls to component object model (COM) and distributed COM (DCOM) components and database connection strings can also be objectized into C2 objects. In addition to user interfaces, C2 objects can be dragged & dropped onto active server pages (ASP) & ASP.NET pages.

Network Software Application Creation Method

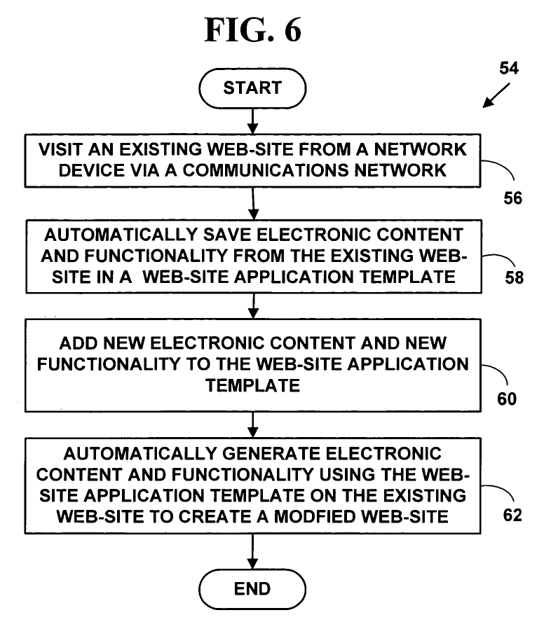

FIG. 6 is a flow diagram illustrating a Method 54 for automatically creating a modified web-site. At Step 56, an existing web-site is visited from a network device via a communication network. At Step 58, electronic content and functionality from a server hosting the existing web-site is saved in a web-site application template on the network device. At Step 60, new electronic content and new functionality is added to the web-site application template. At Step 62, electronic content and functionality for a modified web-site is automatically re-generated on the server hosting the existing web-site from the network device using the new web-site application template to create a modified web-site.

The automatic re-generation of the modified web-site includes, but is not limited to, automatically generating new user interfaces, new m-commerce, e-commerce or e-business interfaces, new databases and database connections, new communications protocol functionality. The modified web-site is a modified web-site application added to an existing web-site including new electronic content and functionality.

Method 54 is illustrated with an exemplary embodiment. However, the invention is not limited to this exemplary embodiment and other embodiments can also be used to practice the invention.

In such an exemplary embodiment at Step 56, an existing web-site is visited from the network device 30 via the communications network 32 with the specialized web browser 26. The web-site could be virtually any information site available on the World-Wide-Web via the Internet 32.

At Step 58, electronic content and functionality from the existing web-site is retrieved from a server 34 hosting the existing web-site and is saved in a web-site application template created with the template generation engine 27 included in the specialized web-browser 26. A look, feel, electronic content and functionality of the existing web-site is retrieved and saved in the web-site application template.

At Step 60, new electronic content and new functionality is added to the web-site application template using the project manager 14, solution engine 16, object engine 18, component engine 20, interface design tool 22, database 24, objectizer 28 and/or solution server 36 with its associated database 36′.

For example, suppose an existing web-site hosted by a server 34 was going to be modified to include a portion of a home page dedicated to the current weather. In such an example, the solution server 36 already has the new electronic content and new functionality in its associated solution database 36′ to provide a current weather solution. A current weather solution is selectable from the tree structure 40 of the project manager 14 interface 38 and draggable and droppable from the tree structure 40 of the project manager 14 into other components of the system 10. The project manager 14, solution engine 16, object engine 18, component engine 20, interface design tool 22, database 24, objectizer 28 would be used to appropriately add the current weather solution selected and provided from the solution server 36 via the communications network 32 to the web-site application template.

At Step 62, electronic content and functionality for a modified web-site is automatically re-generated on the server 34 hosting the existing web-site from the network device 30 using the web-site application template and the component engine 20, thereby creating a modified web-site. In one embodiment, Step 62 includes encrypting non-binary electronic content from the web-site application template to create encrypted non-binary electronic content. Binary electronic content is compressed from the web-site application template to create compressed binary electronic content. The encrypted non-binary electronic content and the compressed binary electronic content is securely transferred from the network device 30 to the server 34 hosting the existing web-site. The non-binary electronic content is decrypted. The binary electronic content is uncompressed. The non-binary electronic content binary content is installed on the existing web-site server 34 to create a modified web-site.

In one embodiment, the encrypted non-binary electronic content and the compressed electronic content are stored in separate locations on the solutions server 36. In other embodiment the encrypted non-binary electronic content and the compressed electronic content are stored in the same location on the solutions server 36.

In one embodiment, only the non-binary electronic content is encrypted. In another embodiment, both the non-binary electronic content and the binary electronic content is encrypted.

In another embodiment, only the binary electronic content is compressed. In another embodiment, both the binary electronic content and the encrypted non-binary electronic content are compressed.

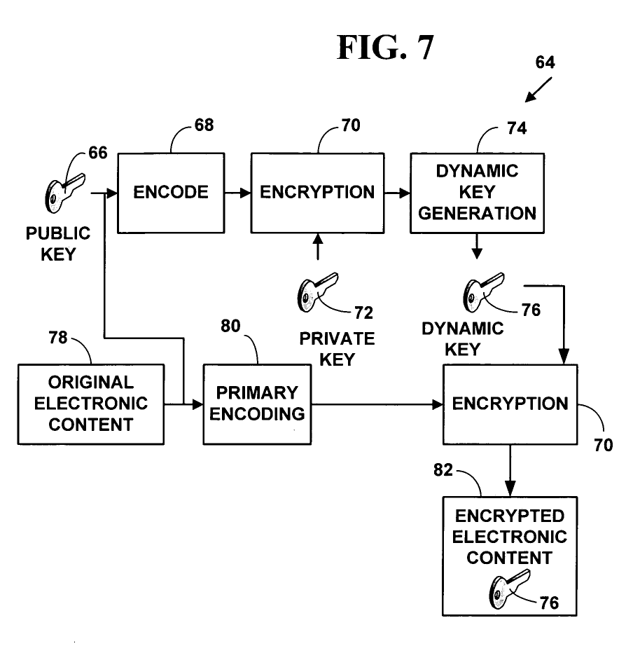

FIG. 7 is a block diagram illustrating an exemplary encryption method 64 used for one embodiment of the invention. However, the present invention is not limited to such an encryption method and other encryption methods can also be used to practice the invention. A public encryption key 66 is encoded 68 and encrypted with a public key encryption method 70 using a private encryption key 72 to generate 74 an original dynamic encryption key 76.

In one embodiment, the public encryption key is base-64 encoded. In another embodiment, the public-key encryption method is not base-64 encoded. In another embodiment, base-X encoding or compression methods known in the art are used to encode the electronic content. In one embodiment, the public-key encryption method is RSA, DES, 3DES, etc. However, the present invention is not limited to encoding methods or the public key encryption methods described and other encoding methods and other public key encryption methods can also be used to practice the invention.

In another embodiment, the original dynamic encryption key 76 is not generated or included with the electronic content 78. In such an embodiment, normal public key encryption methods are used to practice the invention.

As is known in the art base-64 encoding takes three bytes, each consisting of eight bits, and represents them as four characters from the ASCII standard. There are 128 standard ASCII codes each of which can be represented by a 7 digit binary number: 0000000 through 1111111, plus parity bits.

Base-64 encoding is typically done in two steps. The first step is to convert three bytes to four numbers of six bits. Each character in the ASCII standard consists of seven bits. Base-64 encoding uses only uses 6 bits (corresponding to 2\hat{ }6=64 characters). Typically none of the special characters available in ASCII are used. Typically the 64 characters (hence the name Base-64) are the 10 digits (i.e., zero though nine), 26 lowercase characters, 26 uppercase characters as well as the plus sign “+” and the divide sign “/”. These numbers are converted to ASCII characters in the second step using a Base-64 encoding table.

For example, in one embodiment, electronic content is encoded using base-64 encoding and then encrypted. In another embodiment of the invention, base-64 encoding is used directly as a public-key encryption method. However, the present invention is not limited to the public key encryption methods described and other public key encryption methods can also be used to practice the invention.

Original electronic content 78 is encoded 80 in a pre-determined format (e.g., base-64 encoding, base-X encoding, any compression encoding formats known in the art, etc.) for transmission over communications network 32 and encrypted with the public key encryption method 70 using the generated original dynamic encryption key 76 to form encrypted non-binary electronic content 82. The original dynamic encryption key 74 is encrypted with the private key 72 using a base-64 encryption method and included in the encrypted electronic content 82 and securely transferred from the network device 30 to the server 34 hosting the existing web-site.

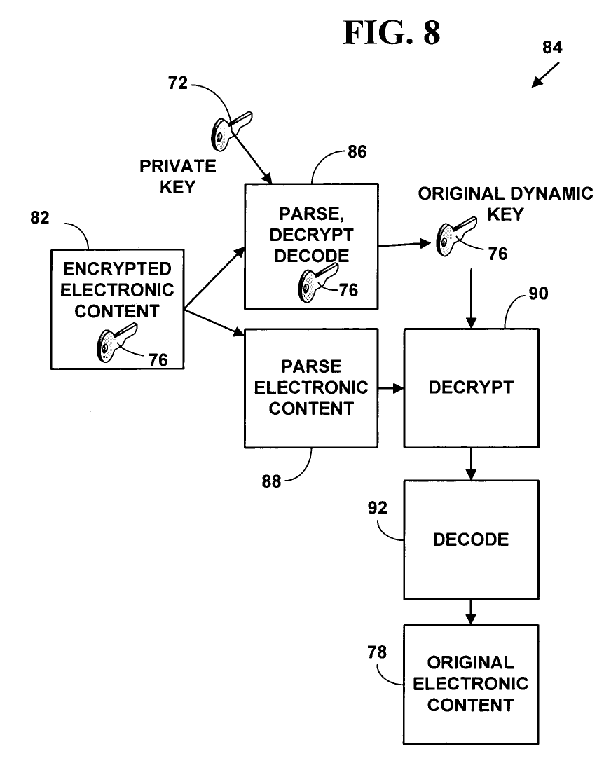

FIG. 8 is a block diagram illustrating an exemplary decryption method 84 used for one embodiment of the invention. However, the present invention is not limited to such an encryption method and other encryption methods can also be used to practice the invention. The encrypted original electronic content 86 is parsed to locate the encrypted dynamic encryption key. The encrypted dynamic encryption key is decrypted 86 with the private key 72 to return the original dynamic encryption key 76.

In one embodiment, the decryption method is a base-64 public-key decryption method. In another embodiment, the decryption method is RSA, DES, 3DES, etc. using base-64 decoding. In other embodiment of the invention, the decryption is RSA, DES, 3EDES without base-64 decoding. However, the present invention is not limited to the public key decryption methods described and other public key decryption methods can also be used to practice the invention.

The encrypted non-binary electronic content 86 is parsed 88 and decrypted 90 using the original dynamic encryption key 72. The decrypted non-binary electronic content is decoded 92 (e.g., with base-64 decoding, etc.) to return the original electronic content 78. The original electronic content 78 is used to replace electronic content on the existing web-site to create a modified web-site on the server 34 hosting the existing web-site.

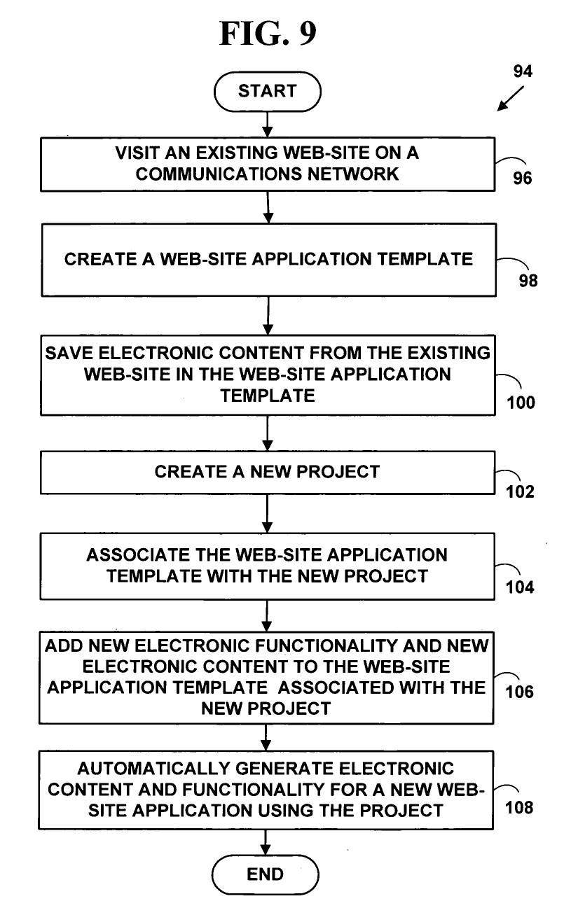

FIG. 9 is a flow diagram illustrating a Method 94 for automatically creating a modified web-site. At Step 96, an existing web-site is visited from a network device via a communication network. At Step 98, a web-site application template is created. At Step 100, electronic content and functionality from a server hosting the existing web-site is saved in the web-site application template on the network device. At Step 102, a new project is created. At Step 104, the web-site application template is associated with the new project. At Step 106, new electronic content and new functionality is added to the web-site application template associated with the new project. At Step 188, electronic content and functionality for a modified web-site is automatically re-generated on the server hosting the existing web-site from the network device using the new project with the associated web-site template to create a modified web-site.

dMethod 94 is illustrated with an exemplary embodiment. However, the invention is not limited to this exemplary embodiment and other embodiments can also be used to practice the invention.

In such an exemplary embodiment at Step 96, an existing web-site is visited from the network device 30 via the communications network 32 with the specialized web browser 26. The web-site could be virtually any information site available on the World-Wide-Web via the Internet 32.

At Step 98, a web-site application template is created using the template generation engine 27 in the specialized web-browser 26. The web-site application template is used to store existing electronic content and functionality from the existing web-site.

At Step 100, electronic content and functionality from the existing web-site is automatically saved in the web-site application template. A look, feel, electronic content and functionality of the existing web-site and save it in the web-site application template. The template generation engine 27 in the specialized browser 26 generates a template and saves all electronic content from the existing web-site including electronic text, graphical images, graphic styles including colors, electronic links, scripts (e.g., Java and VB scripts) and functionalities such as e-commerce, e-business, etc.

At Step 102, a new project is created using the project manager 14. A project description is created for the new project. The new project description includes a new project definition.

At Step 104, the web-site application template is associated with the new project. The web-site application template is added to the new project via the project manager 14. The solution engine 16 and/or the component engine 20 creates a directory structure for the project and generates all required system files and handlers within the directory structure. The solution engine 16 and/or the component engine 20 generates user interfaces using the web-site application template. The solution engine 16 and/or the component engine 20 changes all pointers and references contained in the web-site application template within the web-site application template to match those designated by the new project definition. The solution engine 16 and/or the component engine 20 copies and registers all required binary files on a designated web or application server 34. The new project description is saved into the database 24. The new project description appears on the design interface tool 22 (FIG. 4).

At Step 106, new electronic functionality and new electronic content is added to the web-site application template associated with the new project. The solution engine 16 is used to add new functionality and electronic content. A user can also add new functionality by selecting pre-existing C2 objects from a library of C2 objects stored in database 24. A user “drags and drops” existing functionality from the design tool interface 22 into the new project by selecting existing C2 objects. The design tool interface 22 includes access to a library of existing C2 objects that can be dropped and dragged into the new project. As is know in the art, Microsoft object-linking and embedding (OLE) drag and drop technology allows the user to drag data (such as text or graphics) from one control or application to another control or application.

Tables 1 illustrates some of the pre-existing C2 functionality objects that can be selected and dragged and dropped into a new project. However, the present invention is not limited to these C2 functionality objects, and more fewer or other types of objects can also be used to practice the invention.

TABLE 1

Registration object
Login object
Home page object
Item search object
Search result object
E-commerce object
Item auction object
Auction bidding object
Auction bid conformation object
M-commerce object
Goods or Services Information object

At Step 108, electronic content and functionality for a modified web-site application is automatically generated by the component engine 20 using the new project and the associated web-site application template. The component engine 20 automatically generates all software instructions necessary to create user interfaces, reference system components, data base connections, e-commerce connections, m-commerce connections, e-business connections, communication protocol connections, etc. The modified web-site application is immediately ready for testing or use on server 34. The electronic content and functionality for the new web-site is automatically generated on the server 34 hosting the existing web-site from the network device 30 using the new web-site application template associated with the project to create a modified web-site.

In one embodiment, Step 108 includes encoding/decoding, encrypting/decrypting (FIGS. 7 & 8) non-binary electronic content and compressing/decompressing binary content for secure transmission across the communications network 32 from the network device 30 to the server 34 hosting the existing web-site as was described above for Method 54. However, Step 78 is not limited to this embodiment and other methods of secure transmission can also be used to practice the invention (e.g., SSL, IPsec, encryption, etc.).

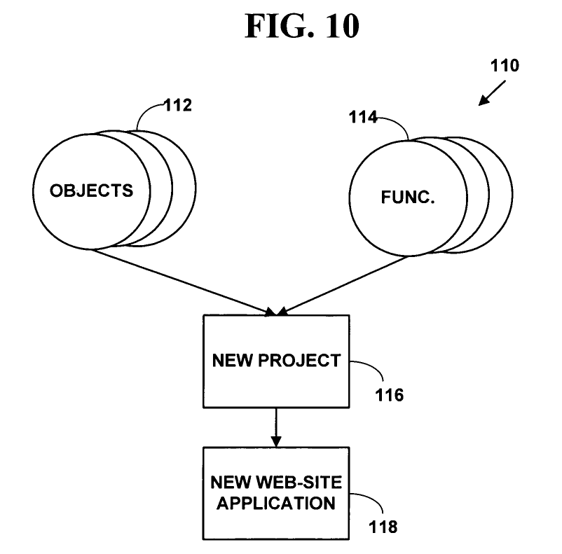

FIG. 10 is a block diagram 110 illustrating additional details of Method 94. The network software application system 10 using methods described herein is tightly integrated to form an easy to use environment, fine tuned for quick assembly of web-based solutions using pre-existing, fully operational components including C2 objects 112 and functionality 114 combined to form various desired solutions. These components are integrated and managed within a new project 116 to eventually create a new or modified web-site, or web-site applications 118. In addition, these components provide the functionality of a traditional web development tool, including a fully functional visual design interface and a HTML code editor.

Creating Re-Usable Network Application Software Solutions

The solution engine 16 is also used to create new solutions that can be selected via the automated design application 12 and used to design brand new web-sites or enhance existing web-sites to create modified web-sites as was described above.

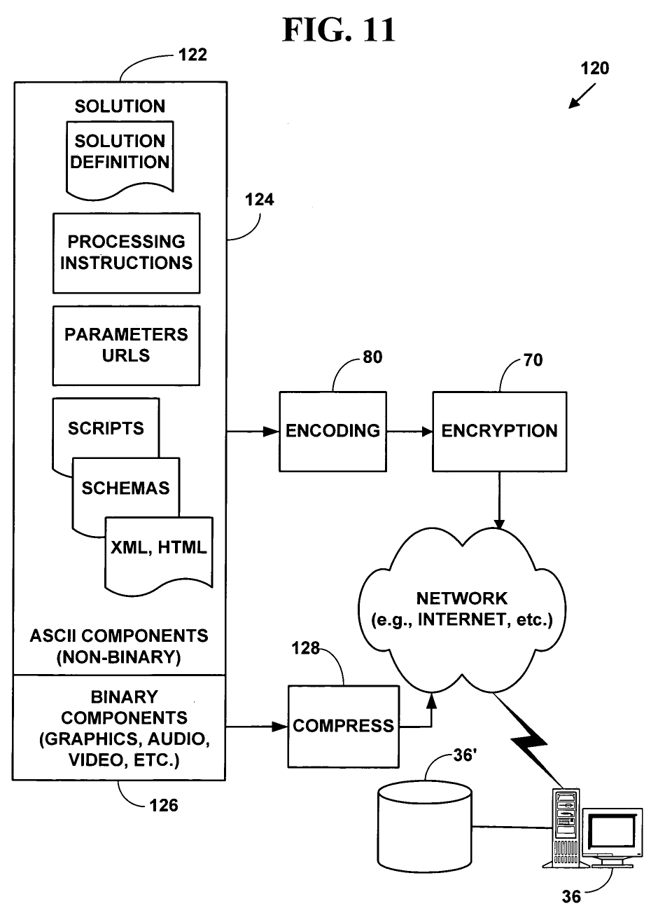

FIG. 11 is a block diagram illustrating a method 120 for storing a created solution created with the solution engine 16. A solution 122 includes non-binary components 124 including but not limited to, a solution definition, solution processing instructions including URLs to the solutions non-binary and binary components, parameters, scripts, schemas, mark-up language components, plain electronic text, etc. A solution also includes binary components 126 such as graphics, digital photos, executable files, libraries, audio, video, etc.

In one embodiment, the non-binary components 124 are encoded 80 in a pre-determined format and encrypted 70 as described for FIG. 7 and securely transmitted via the communications network 32 to the solution server 36 for storage in the solution server database 36′. However, the present invention is not limited to such an embodiment and other embodiments can be used to practice the invention.

In one embodiment, the binary components 126 are compressed 128 and securely sent via the communications network 32 to the solution server 36. In one embodiment, the solution server 36 includes File Transfer Protocol (FTP) functionality. In such an embodiment, the compressed binary components are sent and received using FTP via the solution server 36. However, the present invention is not limited to such embodiments and other embodiments can be used to practice the invention.

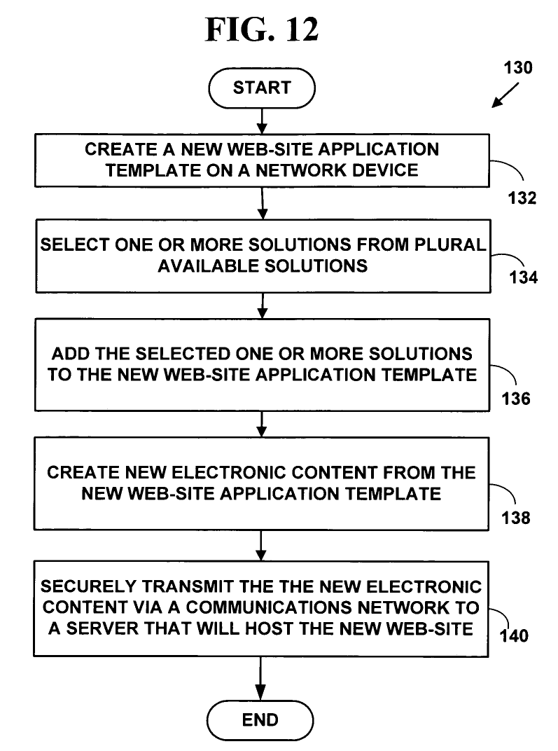

FIG. 12 is a flow diagram illustrating a method 130 for creating a new web-site. At Step 132, a new web-site application template is created on a network device. At Step 134, one or more existing solutions from plural available solutions are selected. At Step 136, the one or more selected solutions are added to the new web-site application template. At Step 138, new electronic content is created from the new web-site application template. At Step 140, the new electronic content is securely transmitted via a communications network to a server that will host the new web-site. At Step 142, the electronic content is automatically installed on the server, thereby creating a new web-site on the server.

Method 130 is illustrated with an exemplary embodiment. However, the invention is not limited to this exemplary embodiment and other embodiments can also be used to practice the invention.

In such an exemplary embodiment at Step 132, a new web-site application template is created on a network device 30 with the template generation engine 27 in the specialized web-browser 26. In another embodiment, the project manager 14 is used to create a new web-site application template via the template generation engine 27 associated with the specialized web-browser 26.

At Step 134, one or more existing solutions 122 from plural available solutions 122 are selected. The solutions are selected via the project manager 14 using the solution engine 16. The solutions 122 are obtained from the one or more or solution databases 36′ via the one or more solution servers 36 via the communications network 32.

For example, a user may desire to create a new web-site for a m-commerce application. At Step 134, the one or more existing solutions 122 that may be selected for the new web-site, include, but are not limited to, a user login solution, a welcome page solution, a user registration solution, a m-commerce solution, etc. Desired solutions 122 are selected and dragged and dropped using the project manager 14. The solution engine 16 automatically obtains the desired solutions from the one or solution servers via the communications network 32.

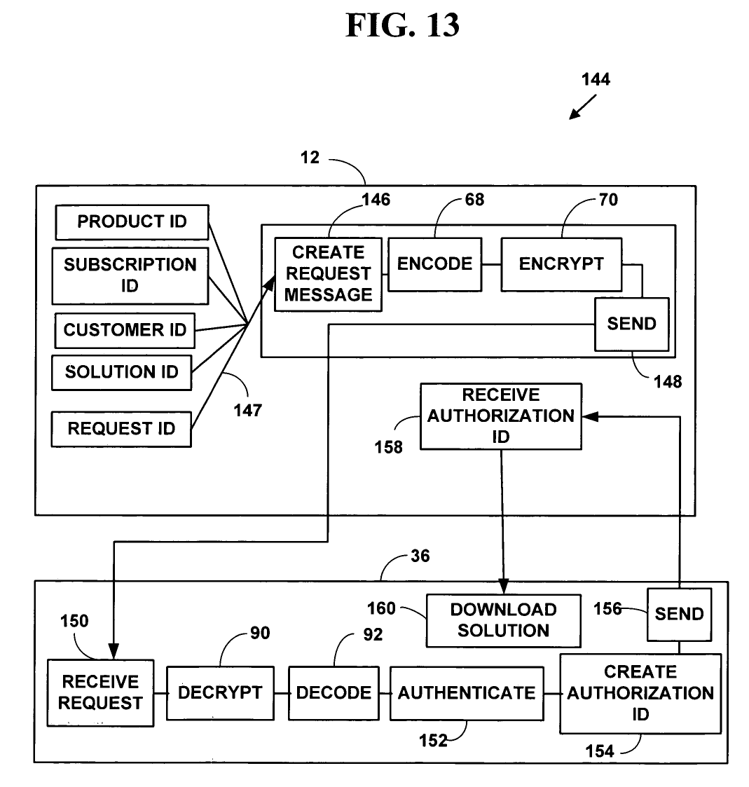

FIG. 13 is a data flow diagram 144 illustrating additional details of selection of a solution 122 at Step 134. However, the invention is not limited to such an embodiment and other embodiments can also be used to practice the invention at Step 134. In such an exemplary embodiment at Step 134, a solution request message is created 146 on the automated design application 12. The solution request message includes one or more identifiers 147 and is encoded 80 and encrypted 70 as was described above for FIG. 7. The encrypted solution request message is sent 148 to the solution server 36. The solution server 36 receives the solution request message 150, decrypts and decodes 82-92 the solution request message as was described above for FIG. 8. The solution server 36 authenticates the solution request message 152, creates an authorization identifier 154, sends 156 it back to the automated design application 12. The automated design application 12 receives 158 the authorization identifier 144 and requests download 160 of the selected solution 122 from the solution server 36.

In one embodiment, the non-binary components 124 of solutions 122 are stored in the solutions database 36′ as encrypted 64 non-binary components as was described above for FIG. 7. Binary components are stored in the solution database 36′ in a compressed format as was described above. However, the present invention is not limited to such an embodiment the solutions 122 can be stored in other encrypted and non-encrypted formats.

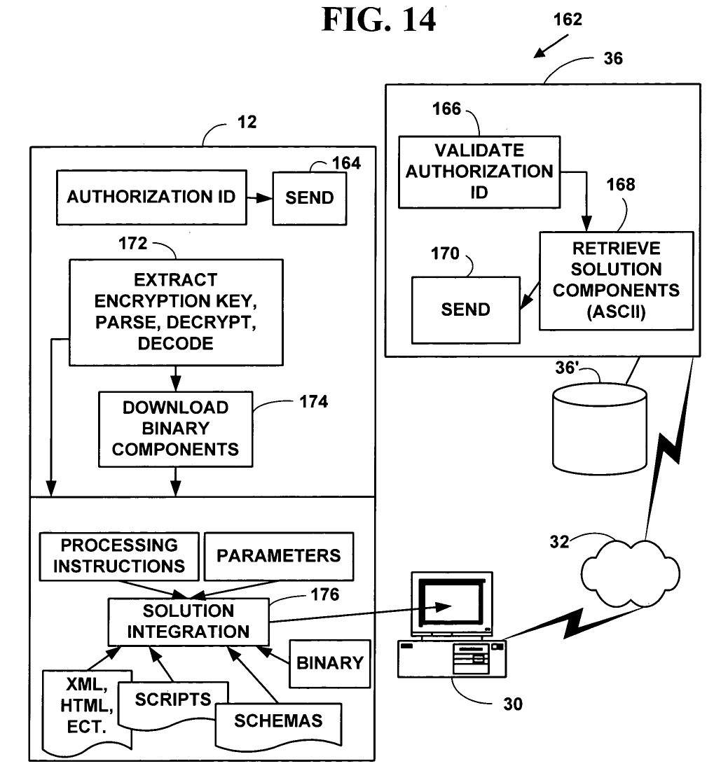

FIG. 14 is a data flow diagram 162 further illustrating additional details of selection of a solution 122 at Step 134. However, the invention is not limited to such an embodiment and other embodiments can also be used to practice the invention at Step 134. In such an exemplary embodiment at Step 134, the automated design application 12 sends 164 the authorization identifier to the solutions server 36. The solution server 36 validates 166 the authorization identifier and retrieves 168 the non-binary components 124 of the solution 122 from the solution database 36′ via the solutions server 36. The solution server 36 sends 170 the encrypted non-binary components of the solution 122 to the automated design application 12. The automated design application 12 processes 172 encrypted non-binary components 124 to retrieve the original non-binary components 124. The encrypted non-binary components 122 are parsed, decrypted and decoded 84-92 as was discussed above for FIG. 8.

In one embodiment, the non-binary components 124 of the solution 122 include URLs to the binary components 126 of the solution 122. The URLs are used to retrieve 174 the binary components 124 of the solution 122 from locations in the solution database 36′ via the solution server 36. The automated design application 12 uses 176 information (e.g., processing instructions, parameters, etc.) from the non-binary components 124 of the solution 122 to integrate the solution 122 in the current project and/or development environment.

Returning to FIG. 12 at Step 136, the one or more selected solutions are added to the new web-site application template using the project manager 14, solution engine 16, object engine 18, component engine 20, interface design tool 22, database 24, objectizer 28 and one or more solution servers 36 with their one or more associated databases 36′.

At Step 138, the new web-site application template is securely transmitted via a communications network to a server that will host the new web-site. In one embodiment, Step 138 includes encoding/decoding, encrypting/decrypting (FIGS. 7 & 8) non-binary electronic content and compressing/decompressing binary content for secure transmission across the communications network 32 from the network device 30 to the server 34 hosting the new web-site as was described above for Method 54. However, Step 128 is not limited to this embodiment and other methods of secure transmission can also be used to practice the invention (e.g., SSL, IPsec, TLS, encryption, etc.).

At Step 140, the new electronic content and functionality from the new web-site application template is automatically installed from the network device 30 on the server 34 hosting the new web-site via the communications network thereby creating a new Web-site on the server 34. The component engine 20 automatically generates all software instructions necessary to create user interfaces, reference system components, data base connections, e-commerce connections, e-business connections, communication protocol connections, etc. The new web-site application is immediately ready for testing or use on the server 34.

The method and system described herein turn complex code, functionality, web-services, and even entire web-based solutions into C2 objects or other types of objects including object-oriented objects that can be downloaded, dropped and dragged into new or existing web applications. The method and system described here provides a tool set used to rapidly develop web-based applications. The method and system provides the functionality of a traditional web development tool, including a fully functional visual design interface, code editor, spell checker, and support for images, video, server-side scripting, client-side scripting, dynamic HTML, XML and data access.

The method and system automatically gathers and organizes all resources required to build a web-based application within a single project. The method and system departs from traditional development environments by providing the ability to download C2 objects and entire web-site solutions. These C2 objects and web-site solutions can be dragged and dropped into any web application and in most cases are fully functional without any additional coding. Generic or custom solutions can be added to a project to capture specific business processes and functionality.

The object engine 18 and solution 16 engines automatically integrates all required interfaces, objects, parameters, system files and components into a new project. The template engine in the specialized web-browser 26 captures the look, feel, and content of almost any existing web-site and uses it as a template in any new project. This can vastly decrease the amount of time and technical knowledge required to develop a custom web-based solution. Any code such as HTML, dHTML, XML, JavaScript, and VB Script can be objectized. Calls to COM components and database connection strings can also be objectized. ASP & ASP.NET is also supported. The method and system described herein are used for automatically designing, implementing and deploying a new web-site, or a modified web-site.

It should be understood that the architecture, programs, processes, methods and systems described herein are not related or limited to any particular type of computer or network system (hardware or software), unless indicated otherwise. Various types of general purpose or specialized computer systems may be used with or perform operations in accordance with the teachings described herein.

In view of the wide variety of embodiments to which the principles of the present invention can be applied, it should be understood that the illustrated embodiments are exemplary only, and should not be taken as limiting the scope of the present invention. For example, the steps of the flow diagrams may be taken in sequences other than those described, and more or fewer elements may be used in the block diagrams.

While various elements of the preferred embodiments have been described as being implemented in software, in other embodiments hardware or firmware implementations may alternatively be used, and vice-versa.

The claims should not be read as limited to the described order or elements unless stated to that effect. In addition, use of the term “means” in any claim is intended to invoke 35 U.S.C. §112, paragraph 6, and any claim without the word “means” is not so intended.

Therefore, all embodiments that come within the scope and spirit of the following claims and equivalents thereto are claimed as the invention.

1. A network software design application creating system, comprising in combination:
a project manager for automatically gathering, organizing and tracking resources for building web-based applications and for allowing switching between design related tasks and project management tasks;
a solution engine for automatically integrating new application interfaces, specialized objects, parameters, system files, processes and functional components;
an object engine for automatically managing the implementation of specialized objects;
a component engine for automatically processing instructions, parameters, scripts, schemas, mark-up language tags, binaries including images, executables, and specialized objects, for storing plural component definition units in a mark-up language format, for automatically generating new software instructions necessary to create new user interfaces, reference system components, data base connections and communication protocol connections;
an interface design tool for automatically integrating a markup language editor with word processing-like features, a source code editor, spell checker, and support for images, audio clips, video clips and scripts;
a specialized web-browser with a template generator engine for automatically capturing a look, feel, content and functionality of any existing web-site and for storing any captured electronic information as an automatically generated template in a project;
an objectizer for creating new specialized objects and for modifying existing specialized objects; and
one or more database for storing specialized objects, projects and templates.

2. The network software design application creating system of claim 1 further comprising:
one or more solution servers with one or more associated solution databases including for storing new solutions and retrieval of existing solutions that provide new electronic content and new functionality for a new web-site that is being created or an existing web-site that is being enhanced.

3. The network software design application creating system of claim 2 wherein a solution includes electronic content and software instructions to accomplish a desired functionality.

4. A network software design application creating system, comprising in combination:
a means for visiting an existing web-site from a network device via a communication network;
a means for automatically saving existing electronic content and functionality from an existing web-site server hosting the existing web-site in a web-site application template on the network device;
a means for adding new electronic content and new functionality to the web-site application template on the network device; and
a means for automatically re-generating electronic content using the web-site application template on the existing web-site server to create a modified web-site with new electronic content and new functionality.

5. The network software design application creating system of claim 4 further comprising:
a means for storing new solutions and retrieval of existing solutions that provide new electronic content and new functionality for a web-site that is being created or an existing web-site that is being enhanced.

6. The network software design application creating system of claim 5 wherein a solution includes electronic content and software instructions to accomplish a desired functionality.

7. A method for automatically generating a modified web-site, comprising:
visiting an existing web-site from a network device via a communication network;
automatically saving existing electronic content and functionality from an existing web-site server hosting the existing web-site in a web-site application template on the network device;
adding new electronic content and new functionality to the web-site application template on the network device; and
automatically re-generating electronic content using the web-site application template on the existing web-site server to create a modified web-site with new electronic content and new functionality.

8. The method of claim 7 further comprising a computer readable medium having stored therein instructions for causing one or more processors to execute the steps of the method.

9. The method of claim 7 wherein the step of automatically saving existing electronic content includes using a specialized web-browser with a template generation engine to capture a look, feel, electronic content and functionality of the existing web-site and save it in the web-site application template.

10. The method of claim 7 wherein the step of adding new electronic content and new functionality to the web-site application template on the network device includes adding new electronic content and new functionality to the web-site application template using:
a project manager for automatically gathering, organizing and tracking resources for building web-based applications and for allowing switching between design related tasks and project management tasks;
a solution engine for automatically integrating new application interfaces, specialized objects, parameters, system files and e-commerce and e-business processes and functional components;
an object engine for automatically managing the implementation of specialized objects;
a component engine for automatically processing instructions, parameters, scripts, schemas, mark-up language tags, binaries including images, executables, connection objects, for storing plural component definition units in a mark-up language format, for automatically generating new software necessary to create new user interfaces, reference system components, data base connections, e-commerce connections, and communication protocol connections;
an interface design tool for automatically integrating a markup language editor with word processor-like features, a source code editor, spell check, and support for images, video clips and scripts;
an objectizer for creating new specialized objects and for modifying existing specialized objects; and
one or more database for storing specialized objects, projects and templates.

11. The method of claim 7 wherein the step of automatically re-generating electronic content using the web-site application template on the existing web-site to create a web-site with new electronic content and new functionality includes:
securely transmitting new electronic content generated from the web-site application template to the existing web-site server; and
automatically installing the electronic content and functionality from the web-site application template on the server host the existing web-site to create a modified web-site.

12. The method of claim 7 wherein the step of automatically re-generating electronic content using the web-site application template on the existing web-site to create a web-site with new electronic content and new functionality includes:
encrypting non-binary electronic content from the web-site application template to create encrypted non-binary electronic content;
compressing binary electronic content; from the web-site application template to create compressed binary electronic content;
securely transmitting the encrypted non-binary electronic content and the compressed binary electronic content from the network device to the existing web-site server;
decrypting the non-binary electronic content;
uncompressing the binary electronic content; and
installing the non-binary electronic content binary content on the existing web-site server to create a modified web-site.

13. The method of claim 7 wherein the step of adding new electronic content and new functionality to the web-site application template on the network device includes selecting one or more existing solutions from a plurality of available solutions, wherein a solution includes electronic content and software instructions to perform a desired functionality on a web-site.

14. A method for automatically generating a new web-site, comprising:
creating a new web-site application template on a network device;
selecting one or more existing solutions from a plurality of available solutions, wherein a solution includes electronic content and software instructions to perform a desired functionality on a web-site;
adding the one or more selected solutions to the new web-site application template;
creating new electronic content from the new web-site application template;
securely transmitting the new electronic content via a communications network to a server that will host the new web-site; and
automatically installing the new electronic content on the server, thereby creating a new web-site on the server.

15. The method of claim 14 further comprising a computer readable medium having stored therein instructions for causing one or more processor to execute the steps of the method.

16. The method of claim 14 wherein the step selecting one or more existing solutions from a plurality of available solutions includes selecting one or more existing solutions via a solution server, wherein the solution server includes one or more associated databases including a plurality of existing solutions usable to provide electronic content to perform a desired functionality on a web-site.

17. The method of claim 14 wherein the step of adding the one or more selected solutions to the new web-site application template includes adding the one or more selected solutions to the new web-site application includes using:
a project manager for automatically gathering, organizing and tracking resources for building web-based applications and for allowing switching between design related tasks and project management tasks;
a solution engine for automatically integrating new application interfaces, specialized objects, parameters, system files and e-commerce and e-business processes and functional components;
an object engine for automatically managing the implementation of specialized objects;
a component engine for automatically processing instructions, parameters, scripts, schemas, mark-up language tags, binaries including images, executables, connection objects, for storing plural component definition units in a mark-up language format, for automatically generating new software necessary to create new user interfaces, reference system components, data base connections, e-commerce connections, and communication protocol connections;
an interface design tool for automatically integrating a markup language editor with word processor-like features, a source code editor, spell check, and support for images, video clips and scripts;
an objectizer for creating new specialized objects and for modifying existing specialized objects; and
one or more database for storing specialized objects, projects and templates.

18. The method of claim 14 wherein the plurality of solutions include a non-binary portion and a binary portion.

19. The method of claim 14 wherein the non-binary portion is encoded in a pre-determined format and encrypted using a pre-determined encrypted method.

20. The method of claim 16 wherein the binary portion is compressed with a pre-determined compression method.
